(19) United States
(12) Patent Application Publication
(10) Pub. No.: US 2026/0371212 A1
(43) Pub. Date: Nov. 19, 2026

(54) COMMUNICATIONS DEVICES, INFRASTRUCTURE EQUIPMENT AND METHODS

(71) Applicant: Sony Group Corporation, Tokyo (JP)

(72) Inventors: Yuxin WEI, Basingstoke (GB); Vivek SHARMA, Basingstoke (GB); Hideji WAKABAYASHI, Basingstoke (GB); Yassin Aden AWAD, Basingstoke (GB)

(73) Assignee: Sony Group Corporation, Tokyo (JP)

(21) Appl. No.: 19/138,694

(22) PCT Filed: Dec. 18, 2023
(86) PCT No.: PCT/EP2023/086380

§ 371 Date: Jun. 13, 2025

(30) Foreign Application Priority Data
Dec. 23, 2022 (EP) 22216609.2

(51) Int. Cl. H04W 36/36; H04W 52/02

(52) U.S. Cl. CPC H04W 36/362; H04W 52/0206

(57) ABSTRACT

A method of operating a source infrastructure equipment of a wireless communications network in a conditional handover is provided. The method comprises configuring one or more conditions for triggering a handover of a communications device from a source cell provided by the source infrastructure equipment to a target cell provided by a target infrastructure equipment of the wireless communications network. The method comprises transmitting, to the communications device, an indication of the one or more conditions for triggering the handover of the communications device from the source cell to the target cell. The method comprises determining that a Network Energy Saving, NES, mode of at least one of the source cell and the target cell has changed or is expected to change. In response, the method comprises transmitting the evaluation trigger signal to the communications device.

### BACKGROUND

### Field

The present disclosure relates to communications devices, infrastructure equipment of a wireless communications network and methods of operating communications devices and infrastructure equipment of a wireless communications network in a conditional handover.

The present application claims the Paris Convention priority of European patent application number EP22216609.2, the contents of which are hereby incorporated by reference in their entirety.

### Description of Related Art

The “background” description provided herein is for the purpose of generally presenting the context of the disclosure. Work of the presently named inventors, to the extent it is described in this background section, as well as aspects of the description which may not otherwise qualify as prior art at the time of filing, are neither expressly nor impliedly admitted as prior art against the present invention.

Third and fourth generation mobile telecommunication systems, such as those based on the 3GPP defined UMTS and Long Term Evolution (LTE) architecture, are able to support more sophisticated services than simple voice and messaging services offered by previous generations of mobile telecommunication systems. For example, with the improved radio interface and enhanced data rates provided by LTE systems, a user is able to enjoy high data rate applications such as mobile video streaming and mobile video conferencing that would previously only have been available via a fixed line data connection. The demand to deploy such networks is therefore strong and the coverage area of these networks, i.e. geographic locations where access to the networks is possible, may be expected to increase ever more rapidly.

Future wireless communications networks will be expected to support communications routinely and efficiently with a wider range of devices associated with a wider range of data traffic profiles and types than current systems are optimised to support. For example, it is expected future wireless communications networks will be expected to support efficiently communications with devices including reduced complexity devices, machine type communication (MTC) devices, high resolution video displays, virtual reality headsets and so on. Some of these different types of devices may be deployed in very large numbers, for example low complexity devices for supporting the “The Internet of Things”, and may typically be associated with the transmissions of relatively small amounts of data with relatively high latency tolerance.

In view of this there is expected to be a desire for future wireless communications networks, for example those which may be referred to as 5G or new radio (NR) system/new radio access technology (RAT) systems [1], as well as future iterations/releases of existing systems, to efficiently support connectivity for a wide range of devices associated with different applications and different characteristic data traffic profiles. The connectivity of devices is conventionally maintained through the use of so-called “handover” procedures where a communications device changes its access point to a wireless communications network in response to an instruction from the wireless communications network or in response to one or more conditions being met. In view of the wide range device types and capabilities in future wireless communications networks, there is a need for improved handover procedures.

### SUMMARY

The present disclosure can help address or mitigate at least some of the issues discussed above.

Example embodiments can provide a method of operating a source infrastructure equipment of a wireless communications network in a conditional handover. The method comprises configuring one or more conditions for triggering a handover of a communications device from a source cell provided by the source infrastructure equipment to a target cell provided by a target infrastructure equipment of the wireless communications network. The method comprises transmitting, to the communications device, an indication of the one or more conditions for triggering the handover of the communications device from the source cell to the target cell. The method comprises determining that a Network Energy Saving, NES, mode of at least one of the source cell and the target cell has changed or is expected to change. In response, the method comprises transmitting the evaluation trigger signal to the communications device. The evaluation trigger signal indicates to the communications device to evaluate one or more of the conditions for triggering the handover of the communications device from the source cell to the target cell.

Example embodiments can also provide a method of operating a communications device in a conditional handover. The method comprises receiving, from source infrastructure equipment of a wireless communications network, an indication of one or more conditions for triggering a handover of the communications device from a source cell provided by the source infrastructure equipment to a target cell provided by a target infrastructure of the wireless communications network. The method comprises receiving, from the source infrastructure equipment, an evaluation trigger signal indicating to the communications device to evaluate one or more of the conditions for triggering the handover of the communications device from the source cell to the target cell. The evaluation trigger signal is received by the communications device from the source infrastructure equipment in response to a change, or expected change, in a Network Energy Saving, NES, mode of at least one of the source cell and target cell. In response, the method comprises evaluating one or more of the conditions for triggering the handover of the communications device from the source cell to the target cell. The method comprises determining that one or more of the evaluated conditions have been met. In response, the method comprises initiating the handover of the communications device from the source cell to the target cell.

Embodiments can provide an energy efficient conditional handover in a wireless communications network by transmission of an evaluation trigger signal to the communications device in response to determining that the NES mode of at least one of the source and the target cell has changed or is expected to change. The transmission of the evaluation trigger signal allows the wireless communications network to control when the communications device evaluates one or more of the conditions for handover based on a change, or expected change, in an NES mode of at least one of the source and target cell. Since the communications device evaluates one or more of the conditions in response to receiving the evaluation trigger signal (rather than the periodic or continuous evaluation which characterises conventional conditional handover), fewer evaluations of the conditions are expected before a positive evaluation result is reached (i.e. a determination that one or more of the conditions are met), thereby reducing energy consumption in the wireless communications network. Furthermore, as will be appreciated from an understanding of the detailed description below, the transmission of the evaluation trigger signal in response to determining that the NES mode of at least one of the source and the target cell has changed, or is expected to change, means that communications devices are able to switch cells (or remain in a cell) in response to changes, or expected changes, in NES modes. For example, the wireless communications network can efficiently control which communications devices are in which cells in response to changes in NES modes in accordance with, for example, a network planning strategy.

Respective aspects and features of the present disclosure are defined in the appended claims.

It is to be understood that both the foregoing general description and the following detailed description are exemplary, but are not restrictive, of the present technology. The described embodiments, together with further advantages, will be best understood by reference to the following detailed description taken in conjunction with the accompanying drawings.

### BRIEF DESCRIPTION OF THE DRAWINGS

A more complete appreciation of the disclosure and many of the attendant advantages thereof will be readily obtained as the same becomes better understood by reference to the following detailed description when considered in connection with the accompanying drawings wherein like reference numerals designate identical or corresponding parts throughout the several views, and:

FIG. 1 schematically represents some aspects of an LTE-type wireless telecommunication system which may be configured to operate in accordance with certain embodiments of the present disclosure;

FIG. 2 schematically represents some aspects of a new radio access technology (RAT) wireless telecommunications system which may be configured to operate in accordance with certain embodiments of the present disclosure;

FIG. 3 is a schematic block diagram of an example of a source infrastructure equipment controlling handover of a communications device to a target infrastructure equipment;

FIG. 4 schematically represents a conventional conditional handover procedure;

FIG. 5 is a flow diagram illustrating a method of operating a source infrastructure equipment of a wireless communications network in a conditional handover in accordance with example embodiments;

FIG. 6 is a flow diagram illustrating a method of operating a communications device in a conditional handover in accordance with example embodiments.

### DETAILED DESCRIPTION OF THE EMBODIMENTS

### Long Term Evolution Advanced Radio Access Technology (4G)

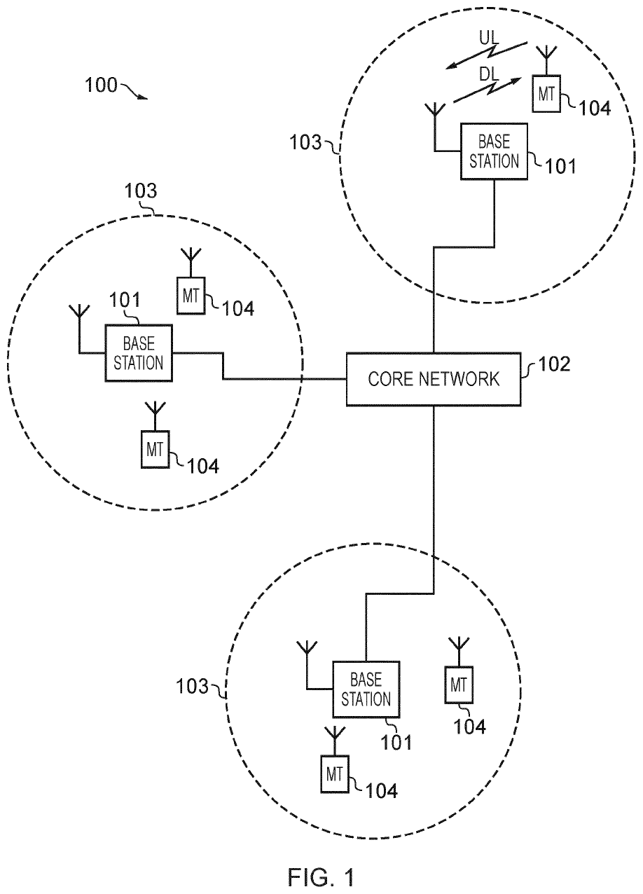

FIG. 1 provides a schematic diagram illustrating some basic functionality of a mobile telecommunications network/system 100 operating generally in accordance with LTE principles, but which may also support other radio access technologies, and which may be adapted to implement embodiments of the disclosure as described herein. Various elements of FIG. 1 and certain aspects of their respective modes of operation are well-known and defined in the relevant standards administered by the 3GPP (RTM) body, and also described in many books on the subject, for example, Holma H. and Toskala A [2]. It will be appreciated that operational aspects of the telecommunications networks discussed herein which are not specifically described (for example in relation to specific communication protocols and physical channels for communicating between different elements) may be implemented in accordance with any known techniques, for example according to the relevant standards and known proposed modifications and additions to the relevant standards.

The network 100 includes a plurality of base stations 101 connected to a core network part 102. Each base station provides a coverage area 103 (e.g. a cell) within which data can be communicated to and from communications devices 104. Data is transmitted from the base stations 101 to the communications devices 104 within their respective coverage areas 103 via a radio downlink. Data is transmitted from the communications devices 104 to the base stations 101 via a radio uplink. The core network part 102 routes data to and from the communications devices 104 via the respective base stations 101 and provides functions such as authentication, mobility management, charging and so on. Communications devices may also be referred to as mobile stations, user equipment (UE), user terminals, mobile radios, terminal devices, and so forth. Base stations, which are an example of network infrastructure equipment/network access nodes, may also be referred to as transceiver stations/nodeBs/e-nodeBs, g-nodeBs (gNB) and so forth. In this regard different terminology is often associated with different generations of wireless telecommunications systems for elements providing broadly comparable functionality. However, example embodiments of the disclosure may be equally implemented in different generations of wireless telecommunications systems such as 5G or new radio as explained below, and for simplicity certain terminology may be used regardless of the underlying network architecture. That is to say, the use of a specific term in relation to certain example implementations is not intended to indicate these implementations are limited to a certain generation of network that may be most associated with that particular terminology.

### New Radio Access Technology (5G)

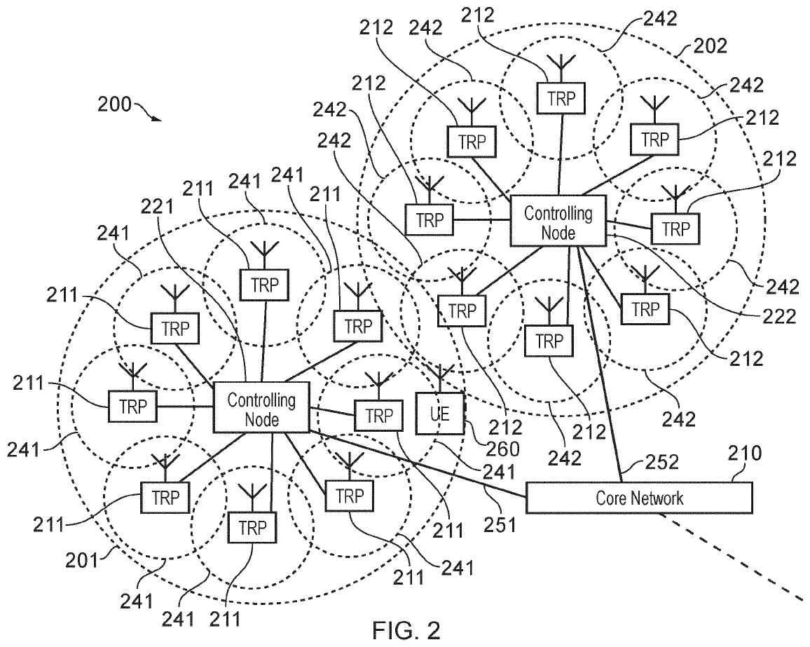

FIG. 2 is a schematic diagram illustrating a network architecture for a new RAT wireless communications network/system 200 based on previously proposed approaches which may also be adapted to provide functionality in accordance with embodiments of the disclosure described herein. The new RAT network 200 represented in FIG. 2 comprises a first communication cell 201 and a second communication cell 202. Each communication cell 201, 202, comprises a controlling node (centralised unit) 221, 222 in communication with a core network component 210 over a respective wired or wireless link 251, 252. The respective controlling nodes 221, 222 are also each in communication with a plurality of distributed units (radio access nodes/remote transmission and reception points (TRPs)) 211, 212 in their respective cells. Again, these communications may be over respective wired or wireless links. The distributed units 211, 212 are responsible for providing the radio access interface for communications devices connected to the network. Each distributed unit 211, 212 has a coverage area (radio access footprint) 241, 242 where the sum of the coverage areas of the distributed units under the control of a controlling node together define the coverage of the respective communication cells 201, 202. Each distributed unit 211, 212 includes transceiver circuitry for transmission and reception of wireless signals and processor circuitry configured to control the respective distributed units 211, 212.

In terms of broad top-level functionality, the core network component 210 of the new RAT communications network represented in FIG. 2 may be broadly considered to correspond with the core network 102 represented in FIG. 1, and the respective controlling nodes 221, 222 and their associated distributed units/TRPs 211, 212 may be broadly considered to provide functionality corresponding to the base stations 101 of FIG. 1. The term network infrastructure equipment/access node may be used to encompass these elements and more conventional base station type elements of wireless communications systems. Depending on the application at hand the responsibility for scheduling transmissions which are scheduled on the radio interface between the respective distributed units and the communications devices may lie with the controlling node/centralised unit and/or the distributed units/TRPs.

A communications device or UE 260 is represented in FIG. 2 within the coverage area of the first communication cell 201. This communications device 260 may thus exchange signalling with the first controlling node 221 in the first communication cell via one of the distributed units 211 associated with the first communication cell 201. In some cases communications for a given communications device are routed through only one of the distributed units, but it will be appreciated that in some other implementations communications associated with a given communications device may be routed through more than one distributed unit, for example in a soft handover scenario and other scenarios.

In the example of FIG. 2, two communication cells 201, 202 and one communications device 260 are shown for simplicity, but it will of course be appreciated that in practice the system may comprise a larger number of communication cells (each supported by a respective controlling node and plurality of distributed units) serving a larger number of communications devices.

It will further be appreciated that FIG. 2 represents merely one example of a proposed architecture for a new RAT communications system in which approaches in accordance with the principles described herein may be adopted, and the functionality disclosed herein may also be applied in respect of wireless communications systems having different architectures.

Thus example embodiments of the disclosure as discussed herein may be implemented in wireless telecommunication systems/networks according to various different architectures, such as the example architectures shown in FIGS. 1 and 2. It will thus be appreciated that the specific wireless communications architecture in any given implementation is not of primary significance to the principles described herein. In this regard, example embodiments of the disclosure may be described generally in the context of communications between network infrastructure equipment/access nodes and a communications device, wherein the specific nature of the network infrastructure equipment/access node and the communications device will depend on the network infrastructure for the implementation at hand. For example, in some scenarios the network infrastructure equipment/access node may comprise a base station, such as an LTE-type base station 101 as shown in FIG. 1 which is adapted to provide functionality in accordance with the principles described herein, and in other examples the network infrastructure equipment/access node may comprise a control unit/controlling node 221, 222 and/or a TRP 211, 212 of the kind shown in FIG. 2 which is adapted to provide functionality in accordance with the principles described herein.

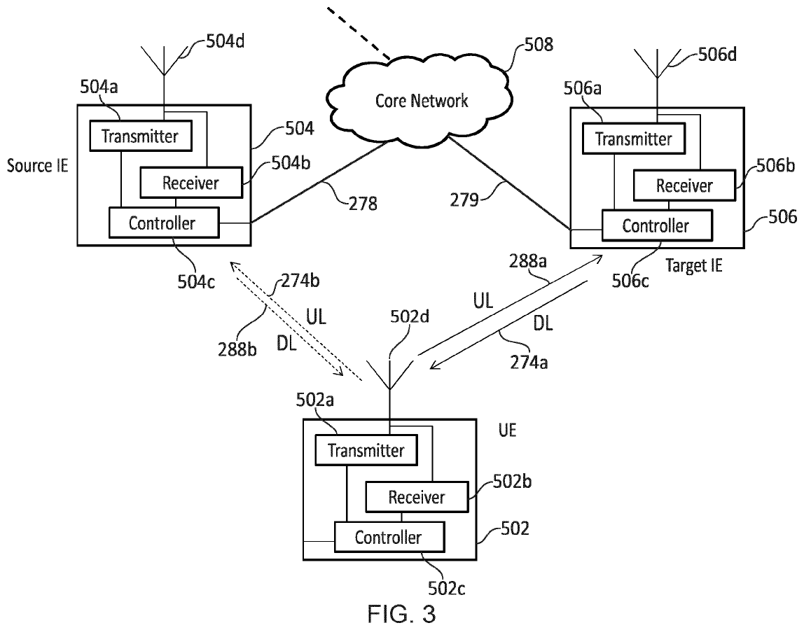

A detailed illustration of a wireless communications network in which a handover may be performed is shown in FIG. 3. As will be appreciated from FIG. 3, a communications device 502 is handed over from a source cell provided by a source infrastructure equipment 504 to a target cell provided by the target infrastructure equipment 506. The source and target cells are not shown in FIG. 3 for clarity, although it will be appreciated that the source and target cells may broadly correspond to cells 3, 12 as discussed in relation to FIGS. 1 and 2 above. The source infrastructure equipment 504 and target infrastructure equipment 506 form part of a radio access network to a core network 508. As will be appreciated the communications device 502 is an example of a communications device such as the communications device 260 of FIG. 2. The communications device 502 may be a UE in one example.

Before the handover, the communications device 502 transmits signals on an uplink UL and receives signals on a downlink DL from a source infrastructure equipment 504. The source infrastructure equipment 504 and the target infrastructure equipment 506 may each be thought of as a gNB 101 or a combination of a controlling node 221 and TRP 211. Before the handover, the communications device 502 is shown to transmit uplink data to the source infrastructure equipment 504 via uplink resources UL of a wireless access interface as illustrated generally by dashed arrow 274b to the source infrastructure equipment 504. The communications device 502 may similarly be configured to receive downlink data transmitted by the source infrastructure equipment 504 via downlink resources DL as indicated by dashed arrow 288b from the source infrastructure equipment 504 to the communications device 502. After the handover, the communications device 502 is shown to transmit uplink data to the target infrastructure equipment 506 via uplink resources UL of a wireless access interface as illustrated generally by solid arrow 288a to the target infrastructure equipment 506. The communications device 502 may similarly be configured to receive downlink data transmitted by the target infrastructure equipment 506 via downlink resources DL as indicated by solid arrow 274a from the target infrastructure equipment 506 to the communications device 502.

In FIG. 3, the source and target infrastructure equipment 504, 506 are each connected to a core network 508 via interfaces 278, 279 to a controller 504c, 506c of the respective infrastructure equipment 504. The source and target infrastructure equipment 504, 506 each include a receiver 504b, 506b connected to an antenna 504d, 506d and a transmitter 504a, 506a connected to the antenna 504d, 506d. Correspondingly, the communications device 502 includes a controller 502c connected to a receiver 502b which receives signals from an antenna 502d and a transmitter 502a also connected to the antenna 502d.

The controllers 504c, 506care configured to control the source and target infrastructure equipment 504, 506 respectively and may comprise processor circuitry which may in turn comprise various sub-units/sub-circuits for providing functionality as explained further herein. These sub-units may be implemented as discrete hardware elements or as appropriately configured functions of the processor circuitry. Thus the controllers 504c, 506c may comprise circuitry which is suitably configured/programmed to provide the desired functionality using conventional programming/configuration techniques for equipment in wireless telecommunications systems. The transmitters 504a, 506a and the receivers 504b, 506b may comprise signal processing and radio frequency filters, amplifiers and circuitry in accordance with conventional arrangements. The transmitters 504a, 506a the receivers 504b, 506b and the controllers 504c, 506c are schematically shown in FIG. 3 as separate elements for ease of representation. However, it will be appreciated that the functionality of these elements can be provided in various different ways, for example using one or more suitably programmed programmable computer(s), or one or more suitably configured application-specific integrated circuit(s)/circuitry/chip(s)/chipset(s). As will be appreciated the infrastructure equipment 504 will in general comprise various other elements associated with its operating functionality.

Correspondingly, the controller 502c of the communications device 502 is configured to control the transmitter 502a and the receiver 502b and may comprise processor circuitry which may in turn comprise various sub-units/sub-circuits for providing functionality as explained further herein. These sub-units may be implemented as discrete hardware elements or as appropriately configured functions of the processor circuitry. Thus the controller 502c may comprise circuitry which is suitably configured/programmed to provide the desired functionality using conventional programming/configuration techniques for equipment in wireless telecommunications systems. Likewise, the transmitter 502a and the receiver 502b may comprise signal processing and radio frequency filters, amplifiers and circuitry in accordance with conventional arrangements. The transmitters 502a, receivers 502b, and controllers 502c are schematically shown in FIG. 3 as separate elements for ease of representation. However, it will be appreciated that the functionality of these elements can be provided in various different ways, for example using one or more suitably programmed programmable computer(s), or one or more suitably configured application-specific integrated circuit(s)/circuitry/chip(s)/chipset(s). As will be appreciated the communications device 502 will in general comprise various other elements associated with its operating functionality, for example a power source, user interface, and so forth, but these are not shown in FIG. 3 in the interests of simplicity.

The controllers 504c, 502c may be configured to carry out instructions which are stored on a computer readable medium, such as a non-volatile memory. The processing steps described herein may be carried out by, for example, a microprocessor in conjunction with a random access memory, operating according to instructions stored on a computer readable medium.

### Conventional Conditional Handover

Aspects of NR are concerned with mobility enhancements and in particular with increasing mobility robustness for new services which require low latency and high reliability performance (such as URLLC). Situations may arise where a cell currently serving a UE may no longer be suitable or a radio link between the UE and a source gNB providing coverage in the cell is degraded. In such situations, it is generally desirable for the UE to switch to being served by a cell of a target gNB. One way of configuring a handover of a UE from a source gNB to a target gNB is referred to as a “conditional handover”.

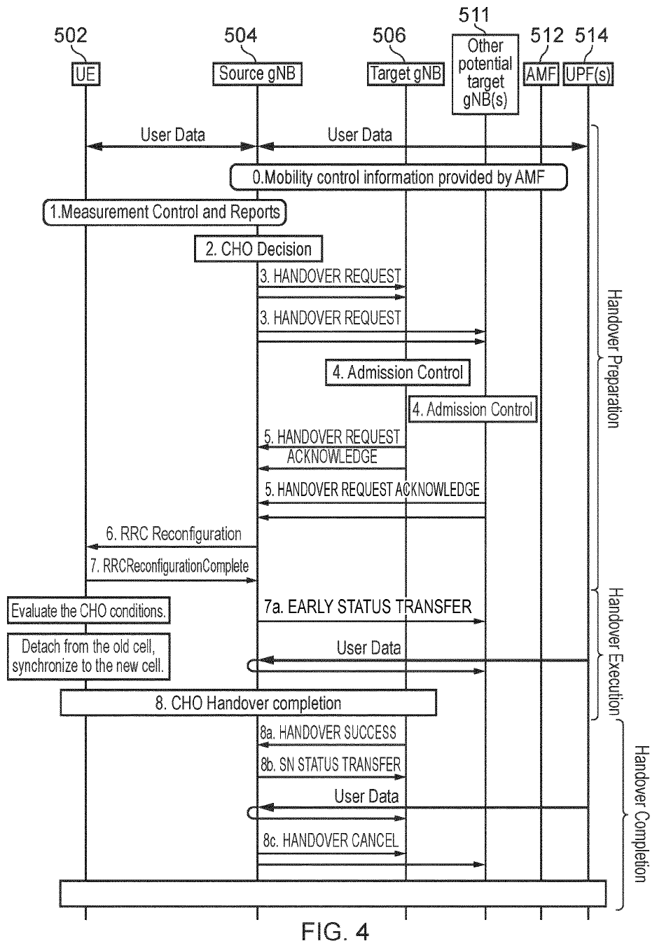

An example of a conditional handover is illustrated in FIG. 4 which is reproduced from [3], the contents of which are incorporated by reference in their entirety. FIG. 4 schematically represents communications in a wireless communications network between the communications device 502, the source infrastructure equipment 504, the target infrastructure equipment 506, other potential target infrastructure equipment 511, an Access Mobility and Mobility Management Function (AMF) 512 and a User Plane Function (UPF) 514. In FIG. 4, the source infrastructure equipment 504, the target infrastructure equipment 506, other potential target infrastructure equipment 511 are depicted as “gNBs”, although it will be appreciated that other infrastructure equipment of a wireless communications network could be used (such as eNBs for example). The AMF 512 and UPF 514 are functions in a core network of the wireless communications network (such as core network 508).

As shown in FIG. 4, before a handover, the communications device 502 communicates user plane data with the AMF 512 and UPF 514 via the source infrastructure equipment 504. In step 0, the AMF 512 provides mobility control information to the source infrastructure equipment 504. In step 1, the communications device 502 reports measurements to the source infrastructure equipment 504. Such measurements may include measurements performed by the communications device 502 such as a Reference Signal Received Power (RSRP), Reference Signal Received Quality (RSRQ) and/or a Signal-to-Interference Ratio (SINR) of reference signals from the source infrastructure equipment 504, the target infrastructure equipment 506 and/or the other potential target infrastructure equipment 511. In step 2, the source infrastructure equipment 504 determines to configure the communications device 502 for a conditional handover. In step 3, the source infrastructure equipment 504 transmits a handover request to the target infrastructure equipment 506 and the other potential target infrastructure equipment 511. In response, in step 4, the target infrastructure equipment 506 and the other potential target infrastructure equipment 511 perform admission control. Then, in step 5, the target infrastructure equipment 506 and the other potential target infrastructure equipment 511 transmit a handover request acknowledgement to the source infrastructure equipment 504. In response to receiving the handover request acknowledgement, the source infrastructure equipment 504 transmits, in step 6, a conditional handover configuration message to the communications device 502. The conditional handover configuration message may be a Radio Resource Control (RRC) configuration message. The conditional handover configuration message includes one or more conditions for triggering a handover of the communications device 502 from a source cell provided by the source infrastructure equipment 504. For example, the one or more conditions in the conditional handover configuration message may include one or more conditions to be met for triggering a handover to target cell provided by the target infrastructure equipment 506 and one or more other conditions to be met for triggering a handover to the other target cells provided by other potential target infrastructure equipment 511. The conditions included in the conditional handover configuration message are explained in more detail below. After receiving the conditional handover configuration message, the communications device 502 transmits an RRC reconfiguration complete message to the source infrastructure equipment 504. After receiving the conditional handover configuration message, the communications device 502 may continuously or periodically evaluate the conditions included in the handover configuration message for triggering the handover to determine whether the conditions for triggering the handover have been met. When the communications device 502 determines that conditions for triggering the handover have been met, the communications device 502 initiates the handover. For example, the communications device 502 detaches from the source cell provided by the source infrastructure equipment 504 and attaches to the target cell provided by the target infrastructure equipment 506. In the example shown in FIG. 4, the communications device 502 determines that the conditions for triggering a handover to the target infrastructure equipment 506 are met. While the communications device 502 is evaluating the conditions, the source infrastructure equipment 604 transmits an early status transfer to the other potential target infrastructure equipment in step 7a, and subsequent user data from the UPF 514 is routed to the other potential target infrastructure equipment 511 via the source infrastructure equipment 504. In step 8, the target infrastructure equipment 506 determines that the handover of the communications device 502 from the source cell provided by the source infrastructure equipment 504 to the target cell provided by the target infrastructure equipment 506 has been successful. In response, the target infrastructure equipment 506 transmits a handover success message to the source infrastructure equipment 504 in step 8a. In step 8b, the source infrastructure equipment 504 transmits an SN status transfer message to the target infrastructure equipment 506. Subsequent user data from the UPF 514 to the source infrastructure equipment is routed to the target infrastructure equipment 506. In step 8c, a handover cancel message is transmitted from the source infrastructure equipment 504 to the target infrastructure equipment and the other potential target infrastructure equipment 511.

As mentioned above in step 6 of FIG. 4, the source infrastructure equipment 504 may transmit a conditional handover configuration message to the communications device 502 including one or more conditions for triggering the handover.

An example of a condition to be met for triggering a handover of the communications device 502 is “event A3”. The condition defined by event A3 is met if a signal quality of a cell provided by a neighbouring infrastructure equipment (for example, the target infrastructure equipment 506 or the other potential target infrastructure equipment 511) becomes a pre-defined offset higher than the signal quality of a cell provided by the source infrastructure equipment 504.

Another example of a condition to be met for triggering a handover of the communications device 502 is “event A4”. The condition defined by event A4 is met if the signal quality of the cell provided by the neighbouring infrastructure equipment is greater than an absolute threshold.

Another example of a condition to be met for triggering a handover of the communications device 502 is “event A5”. The condition defined by event A5 is met if the signal quality of the cell provided by the source infrastructure equipment 504 is less than an absolute threshold and the signal quality of the neighbouring infrastructure equipment is greater than an absolute threshold.

The “signal quality” mentioned above in respect of the definitions of events A3, A4 and A5 may be measured by the communications device 502 using one or more signal quality parameters such as RSRP, RSRQ and SINR. For example, the communications device 502 may determine that condition outlined in event A3 may be met if a measured RSRP of the cell provided by the neighbouring infrastructure equipment becomes a pre-defined offset higher than the measured RSRP for the cell provided by the source infrastructure equipment 504. In another example, may determine that condition outlined in event A3 is met if a measured RSRP and RSRQ of the cell provided by the neighbouring infrastructure equipment each respectively become a pre-defined offset higher than the measured RSRP and RSRQ for the cell provided by the source infrastructure equipment 504. In Release-16 of standards of the 3GPP group, only one reference signal type and measurements of at most two signal quality parameters are supported in determining whether event A3, A4 and/or A5 are met.

Each of events A3, A4 and A5 therefore each represent a condition for triggering a handover of the communications device 502 from the source infrastructure equipment 504. In order to trigger the handover, it may be sufficient that only one condition included in the conditional handover configuration message is met, or the triggering of the handover may require more than one or all of the conditions in the conditional handover configuration message to be met. In one example, only event A3 is included as a condition and the handover is triggered if event A3 is met. In another example, both events A3 and A4 are included as conditions and the handover is triggered if either event A3 or A4 is met. In another example, both events A3 and A4 are included as conditions and the handover is triggered if both events A3 or A4 are met.

Further details of events A3, A4 and A5 are provided in TS 36.331 which is hereby incorporated by reference in its entirety.

### Network Energy Saving (NES)

In Release-18 of the 3PP standards, a new study item has been initiated on Network Energy Saving (NES) ([4]). The objectives of the study item are the following:

### (i) Defining a Base Station Energy Consumption Model

Objective (i) is expected to include adapting frameworks of power consumption modelling and evaluation methodologies for UE power saving in NR (discussed in [5]) to the base station side. This is expected to involve adapting relative energy consumption for DL and UL (considering factors such as Power Amplifier (PA) efficiency, number of TXRU interfaces, base station load, etc), sleep states and associated transition times, and one or more reference parameters/configurations.

### (ii) Defining of an Evaluation Methodology and Key Performance Indicators (KPIs)

Objective (ii) is expected to include targeting the evaluation methodology for evaluating system-level network energy consumption and energy savings gains, as well as assessing/balancing impact to network and user performance (for example, spectral efficiency, capacity, User Perceived Throughput (UPT), latency, handover performance, call drop rate, initial access performance, Service Level Agreement (SLA) assurance related KPIs), energy efficiency, UE power consumption, and complexity. The evaluation methodology is expected to focus on reusing existing KPIs whenever applicable, rather than focussing on a single KPI. Where existing KPIs are found to be insufficient, new KPIs may be developed as needed. It has yet to be determined which KPIs will be evaluated and how.

(iii) Identifying Techniques on the gNB and UE Side to Improve Network Energy Savings in Terms of Both Base Station Transmission and Reception

Objective (iii) is expected to include achieving efficient operation dynamically and/or semi-statically and finer granularity adaptation of transmissions and/or receptions in one or more of network energy saving techniques in time, frequency, spatial, and power domains, with potential support/feedback from UE, and potential UE assistance information. Objective (iii) is also expected to include information exchange/coordination over network interfaces.

The study item is expected to prioritize idle/empty and low/medium load scenarios, with different loads among carriers and neighbour cells being permitted. The exact definition of such loads is expected to be determined as part of the study item.

The following examples of single-carrier and multi-carrier deployments are expected to be prioritized in the study item:
Urban micro in FR1, including Time Division Duplex (TDD) massive Multiple-Input Multiple-Output (MIMO). This can also model small cells.
FR2 beam-based scenarios (note: this scenario can also model small cells)
Urban/Rural macro in FR1 with/without DSS Dynamic Spectrum Sharing (DSS). No impact to LTE expected in case of DSS.
Evolved-Universal Terrestrial Radio Access-New Radio Dual Connectivity (EN-DC)/New Radio Dual Connectivity (NR-DC) macro with Frequency Division Duplex (FDD) Primary Cell (PCell) and TDD/Massive MIMO on higher FR1/FR2 frequency

It intended that existing UEs will be able to continue accessing a network implementing Release-18 network energy savings techniques, with the possible exception of techniques developed specifically for greenfield deployments.

### Network Energy Saving (NES) Modes

It has been proposed that cells provided by infrastructure equipment of a wireless communications network are configured to operate in accordance with NES modes. Table 1 (reproduced from [6]) illustrates examples of proposed NES modes.

TABLE 1
Proposed NES modes.

| | | Relative | Additional | Total |
|---|---|---|---|---|
| | | Power | transition | transition |
| NES Mode | Characteristic | P | energy E | time T |
| Deep sleep | There is neither DL transmission nor UL reception. | P1 | E1 | T1 |
| | Time interval for the sleep is larger than the total | | | |
| | transition time entering and leaving this state. | | | |
| Light sleep | There is neither DL transmission nor UL reception. | P2 | E2 | T2 |
| | Time interval for the sleep is larger than the total | | | |
| | transition time entering and leaving this state. | | | |
| Micro sleep | There is neither DL transmission nor UL reception. | P3 | 0 | 0 |
| | Immediate transition is assumed for network energy | | | |
| | saving study purpose from or to a non-sleep state. | | | |
| Active DL | There is only DL transmission. | P4 | N/A | |
| Active UL | There is only UL reception. | P5 | | |

In Table 1, the transition time, T, for an NES mode is the time taken for a cell to enter or leave that NES mode. The additional transition energy, E, for an NES mode is the energy required for a cell to enter or leave that NES mode relative to a reference energy. The relative power, P, of an NES mode is the power consumed when a cell enters of leaves that NES mode relative to a reference power.

As will be understood by one skilled in the art, the relative power for the deep sleep NES mode is lower than the relative power for the light sleep NES mode which is lower than the relative power for micro sleep NES mode. In other words, P1<P2<P3. Furthermore, as will be understood by one skilled in the art, the relative power of the active UL NES mode has a lower relative power than the active DL NES mode. In other words, P5<P4.

Table 2 (reproduced from [6]) illustrates examples of relative power, P, values for the NES modes shown in Table 1 across different base station categories and reference configuration sets. Further detail on the base station categories and the reference configuration sets can be found in [6].

TABLE 2
Relative Power of Proposed NES modes.

| | BS Category 1 | | | BS Category 2 | | |
|---|---|---|---|---|---|---|
| NES Mode | Set 1 | Set 2 | Set 3 | Set 1 | Set 2 | Set 3 |
| Deep sleep | 1 | | | 1 | | |
| Light sleep | 25 | | | 2.1 | | |
| Micro sleep | 55 | 50 | 38 | 5.5 | 5 | 3 |
| Active DL | 280 | 200 | 152 | 32 | 26 | 17.6 |
| Active UL | 110 | 90 | 80 | 6.5 | 5.8 | 4.2 |

In addition to NES modes proposed in Table 1, other NES modes are envisaged. For example, a cell may be configured to operate in accordance with an NES mode which has a relative power lower than the deep sleep NES mode and requires a larger transition time. This may be referred to as a hibernating sleep, or Quasi-off, NES mode. Another example of an NES mode is an “OFF” NES mode where the cell is turned off for uplink and downlink data transmissions. As will be understood by one skilled in the art, a communications device in a cell in an OFF NES mode may still receive reference signals or send wakeup signal to wake up the cell.

Configuring network cells to operate in accordance with NES modes is expected to improve network energy savings. For example, in accordance with a network planning strategy, different cells in a wireless communications network may operate according to different NES modes. For example, a cell may be configured in a micro sleep NES mode when uplink/downlink traffic is expected imminently in the cell and another cell may be configured in a deep sleep NES mode when uplink/downlink traffic is not expected in the cell for considerable time.

Enhancements to conditional handover for NES have been discussed in [6] and [7], both of which are hereby incorporated by reference in their entirety. In particular, it has been proposed to enhance conditional handover by making the evaluation of conditional handover conditions dependent on the NES mode of the source/target cell. However, in existing conditional handover procedures, communications devices periodically or continuously evaluate handover conditions which can lead to energy wastage. Furthermore, communications devices may not be aware of changes, or expected changes, in NES modes of cells in the wireless communications network. Communications devices may therefore spend too long in cells with NES modes to which the communications device is not suited, leading to further energy wastage. For example, a communications device may be in a cell which has just turned on an NES mode but the communications device cannot be offloaded to another cell until it evaluates the conditions for handover. Therefore, improving the energy efficiency of conditional handover presents technical challenges.

There is therefore a need for communications devices, infrastructure equipment and methods for improving the energy efficiency of conditional handover in wireless communications networks.

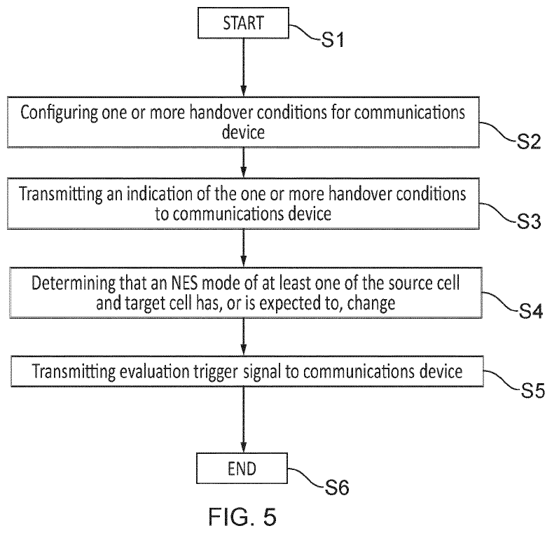

A method of operating a source infrastructure equipment of a wireless communications network in a conditional handover in accordance with example embodiments is shown in FIG. 5. The method starts in step S1.

After step S1, in step S2, the method comprises configuring one or more conditions for triggering a handover of a communications device from a source cell provided by the source infrastructure equipment to a target cell provided by a target infrastructure equipment of the wireless communications network.

The one or more conditions may be explicitly or implicitly based on an NES mode of at least one of the source and target cell. One example of an explicit condition based on the NES mode of the target cell is that the communications device will handover to a target cell if the target cell is configured to operate in accordance with a light sleep or micro sleep NES mode. One example of an implicit condition based on an NES mode of the target cell is that the communications device will handover over to the target cell if the Reference Signal Received Power (RSRP) of the target cell as detected by the communications device is above a predefined threshold. In this example, the target cell may be configured to operate in accordance with a deep sleep NES mode and the source infrastructure equipment configures the RSRP threshold to be relatively high because the target cell is in the deep sleep NES mode. Similarly, if the target cell is configured to operate in accordance with a light sleep NES mode then the source infrastructure equipment may configure the RSRP threshold as being relatively low (i.e. lower than if the target cell was configured to operate in accordance with a deep sleep NES mode). Further examples of conditions for triggering the handover are discussed in the section “Example Conditions for Handover” below.

After step S2, in step S3, the method comprises transmitting, to the communications device, an indication of the one or more conditions for triggering the handover of the communications device from the source cell to the target cell. For example, the source infrastructure equipment may transmit a conditional handover configuration message (such as that described in step 6 of FIG. 4) comprising the one or more conditions for triggering the handover. The conditional handover message may be transmitted as an RRC signal, for example.

After step S3, in step S4, the method comprises determining that a Network Energy Saving, NES, mode of at least one of the source cell and the target cell has or is expected to change.

It will be understood that “change in an NES mode” of a cell includes a cell changing from one NES mode to another NES mode (such as the NES modes shown in Table 1), or changing from not operating in accordance with an NES mode (“NES MODE OFF” state) to operating in accordance with an NES mode (“NES MODE ON” state), or changing from operating in accordance with an NES mode (“NES MODE ON” state) to not operating in accordance with an NES mode (“NES MODE OFF” state). An example of an “NES MODE OFF” state is when a cell is “ON” and is not operating in accordance with an NES mode. An example of an “NES MODE ON” state is when a cell is in the NES MODE where the cell is switched OFF for uplink and downlink data transmission. Another example of an “NES MODE ON” state is when the cell is operating in accordance with any of the NES modes shown in Table 1.

The source infrastructure equipment may determine that the NES mode source cell has changed or is expected to change, or determine that the NES mode of the target cell has changed or is expected to change, or determine that the NES mode of both the source cell and the target cell has changed or is expected to change.

In some embodiments, the source infrastructure equipment may determine that the NES mode of at least one of the source cell and the target cell has changed (i.e. already changed). For example, the source infrastructure equipment may determine that the NES mode of the source cell has changed. In some embodiments, the source infrastructure equipment may determine that the NES mode of the target cell has changed based on an indication that the NES mode of the target cell has changed received from the target infrastructure equipment (for example, via an Xn interface). In some embodiments, the source infrastructure equipment may determine that the NES mode of the target cell has changed because it receives an indication from the target infrastructure equipment that the target cell has changed from operating in accordance with an NES MODE OFF state to operating in accordance with an NES MODE ON state.

In some embodiments, the source infrastructure equipment may determine that the NES mode of at least one of the source cell and the target cell is expected to change (i.e. at some point in the future). For example, the source infrastructure equipment may determine to change the NES mode of the source cell and, in response to this determination, the source infrastructure equipment may transmit the evaluation trigger signal. In another example, the source infrastructure equipment may determine that the NES mode of the target cell is expected to change based on an indication that the NES mode of the target cell is expected to change received from the target infrastructure equipment. For example, the target infrastructure equipment may determine to change the NES mode of the target cell and transmit an indication that the NES mode of the target cell is going to change to the source infrastructure equipment. In one example, the source infrastructure equipment may determine that the NES mode of the target cell is expected to change because it receives an indication from the target infrastructure equipment that the target cell is going to change from operating in accordance with an NES MODE OFF state to operating in accordance with an NES MODE ON state.

After step S4, in step S5, the method comprises, in response, transmitting the evaluation trigger signal to the communications device. The evaluation trigger signal indicates to the communications device to evaluate one or more of the conditions for triggering the handover of the communications device from the source cell to the target cell

In some embodiments, the evaluation trigger signal specifically indicates one or more of the conditions which should be evaluated by the communications device. For example, the evaluation trigger signal may indicate to the communications device to evaluate a subset of the conditions indicated to the communications device by the source infrastructure equipment in step S3. For example, in step S3, the indication of the one or more conditions received from the source infrastructure equipment may indicate a plurality of conditions identified by “Index 1” and “Index 2” respectively. Then, in step S5, the evaluation trigger signal may indicate that the condition identified by Index 1 should be evaluated by the communications device. In other examples, the evaluation trigger signal indicates to the communications to evaluate all of the conditions indicated to the communications device by the source infrastructure equipment in step S3.

In some embodiments, the evaluation trigger signal may comprise an indication of the NES mode of at least one of the source cell and the target cell. For example, one of the conditions may be that the communications device should handover to the target cell if the target cell is in a light sleep NES mode. In this example, the evaluation trigger signal which indicates to the communications device to evaluate the condition also indicates to the communications device that the NES mode of the target cell has changed, or will change, to the light sleep NES mode.

In some embodiments, the target infrastructure equipment determines that the NES mode of the target cell has, or will change, and transmits an indication to the source infrastructure equipment to transmit the evaluation trigger signal to the communications device. Therefore, the source infrastructure equipment determines that the NES mode of the target cell is expected to change based on the indication to transmit the evaluation trigger signal received from the target infrastructure equipment. In this case, the determination is an implicit determination because the indication to transmit the evaluation trigger signal may not comprise an explicit indication that the target cell has changed or is expected to change. In some embodiments, the indication to transmit the evaluation trigger signal to the communications device is transmitted via an Xn interface between the source infrastructure equipment and the target infrastructure equipment. In such embodiments, the target infrastructure equipment effectively triggers the evaluation of the one or more conditions by the communications device. In one example, the target infrastructure equipment may determine that the NES mode of the target cell has changed because the target cell has changed from operating in accordance with an NES MODE ON state to an NES MODE OFF state. For example, the target cell may have been awakened by a communications device in the target cell transmitting a wakeup signal to the target infrastructure equipment. Therefore, the target infrastructure equipment can effectively prompt the handover of the communications device to the target cell when the target cell changes to an NES MODE OFF state.

In some embodiments, the source infrastructure equipment may transmit handover assistance information to the target infrastructure equipment. The target infrastructure equipment may determine, based on a change, or expected change, in the NES mode of the target cell and the handover assistance information, to transmit the indication to transmit the evaluation trigger signal to the source infrastructure equipment. In response, the target infrastructure equipment may then to transmit the evaluation trigger signal to the source infrastructure equipment. The handover assistance information may comprise one or more of a number of communications devices in the source cell as candidates for handover to the target cell, a quality of service required by the communications devices, a service required by the communications devices and a traffic volume required by the communications devices.

In some embodiments, the evaluation trigger signal is an RRC signal dedicated for the communications device. In some embodiments, the evaluation trigger signal is a groupcast RRC signal for reception by a plurality of communications devices in the source cell. In this case, the groupcast RRC signal comprises a Group Common, GC, Radio Network Temporary identifier, RNTI, for identifying the plurality of communications devices in the source cell.

In some embodiments, the evaluation trigger signal is a Medium Access Control, MAC, signal dedicated for the communications device. In some embodiments, the evaluation trigger signal is a groupcast MAC signal for reception by a plurality of communications devices in the source cell. In this case, the groupcast MAC signal comprising a GC-RNTI for identifying the plurality of communications devices in the source cell.

In some embodiments, the evaluation trigger signal is a MAC, Control Element, CE, signal.

In some embodiments, the evaluation trigger signal is a broadcast signal for reception by a plurality communications devices in the source cell.

In some embodiments, the evaluation trigger signal is comprised in group common DCI for reception by a plurality of communications devices in the source cell, the group common DCI comprising a GC-RNTI for identifying the plurality of communications devices in the source cell.

The method ends in step S6.

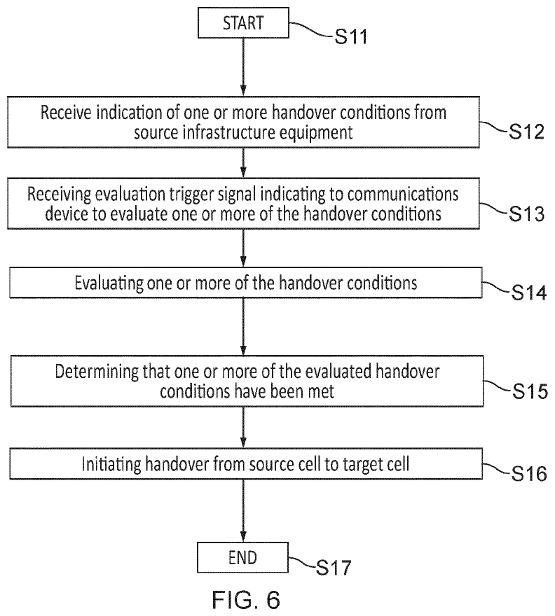

A method of operating a communications device in a conditional handover in accordance with example embodiments is shown in FIG. 6. The method starts in step S11.

After step S11, in step S12, the method comprises receiving, from source infrastructure equipment of a wireless communications network, one or more conditions for triggering a handover of the communications device from a source cell provided by the source infrastructure equipment to a target cell provided by a target infrastructure of the wireless communications network.

After step S12, in step S13, the method comprises receiving, from the source infrastructure equipment, an evaluation trigger signal indicating to the communications device to evaluate one or more of the conditions for triggering the handover of the communications device from the source cell to the target cell. The evaluation trigger signal is received by the communications device from the source infrastructure equipment in response to a change, or expected change, in a Network Energy Saving, NES, mode of at least one of the source cell and target cell.

After step S13, in step S14, the method comprises, in response, evaluating one or more of the conditions for triggering the handover of the communications device from the source cell to the target cell.

After step S14, in step S15, the method comprises determining that one or more of the evaluated conditions have been met.

After step S15, in step S16, the method comprises, in response, initiating the handover of the communications device from the source cell to the target cell.

The initiation of the handover may involve detaching from a wireless access interface or radio link provided by the source infrastructure equipment and attaching to a wireless access interface or radio link provided by the target infrastructure equipment. The initiation of the handover may include establishing a wireless connection with the target relay infrastructure equipment. For example, the communications device may initiate an access procedure with the target infrastructure equipment. In one example, the communications device may initiate a Random Access Channel (RACH) procedure with the target infrastructure equipment.

The method ends in step S17.

As described above with reference to FIGS. 5 and 6, the source infrastructure equipment transmits the evaluation trigger signal to the communications device and the communications device evaluates one or more of the conditions in response. The communications device then determines that the condition is met and initiates the handover. Therefore, embodiments allow the wireless communications network, which is aware of changes, or expected changes, in NES modes, to control when the communications device evaluates the conditions. Since the communications device evaluates one or more of the conditions in response to receiving the evaluation trigger signal (rather than the periodic or continuous evaluation which characterises conventional conditional handover), fewer evaluations of the conditions are expected before a positive evaluation result is reached (i.e. a determination that one or more of the conditions are met), thereby reducing energy consumption in the wireless communications network. Furthermore, the transmission of the evaluation trigger signal in response to determining that the NES mode of at least one of the source and the target cell has changed, or is expected to change, means that communications devices are able to switch cells (or remain in a cell) in response to changes, or expected changes, in NES modes. The wireless communications network can efficiently control which communications devices are in which cells in response to changes in NES modes in accordance with, for example, a network planning strategy.

### Evaluation Stop Signal

In some embodiments, the evaluation trigger signal is transmitted to the communications device by the source infrastructure equipment to indicate to the communications device to evaluate the one or more conditions and a second, subsequent signal (referred to herein as an “evaluation stop signal”) is transmitted to the communications device by the source infrastructure equipment to indicate to the communications device to stop evaluating the one or more conditions.

In some embodiments, the source infrastructure equipment may transmit the evaluation stop signal to the communications device in response to another change in NES mode of at least one of the source and target cell. For example, the source infrastructure equipment may transmit the evaluation trigger signal to the communications device in response to determining that the target cell has changed from the “NES MODE ON” state to the “NES MODE OFF” state. Then, in response to later determining that the target cell has changed from the “NES MODE OFF” state to the “NES MODE ON” state, the source infrastructure equipment may transmit the evaluation stop signal to the communications device.

References to the evaluation stop signal being transmitted in response to “another change in NES mode of at least one of the source and target cell” includes cases where:
The evaluation trigger signal is transmitted in response to a change, or expected change, in the NES mode of the source cell and the evaluation stop signal is transmitted in response to a change, or expected change, in the NES mode of the source cell,
The evaluation trigger signal is transmitted in response to a change, or expected change, in the NES mode of the target cell and the evaluation stop signal is transmitted in response to a change, or expected change, in the NES mode of the target cell,
The evaluation trigger signal is transmitted in response to a change, or expected change, in the NES mode of the source cell and the evaluation stop signal is transmitted in response to a change, or expected change, in the NES mode of the target cell, and
The evaluation trigger signal is transmitted in response to a change, or expected change, in the NES mode of the target cell and the evaluation stop signal is transmitted in response to a change, or expected change, in the NES mode of the source cell.

In some embodiments, the evaluation stop signal may be transmitted based on the expiry of a preconfigured timer.

Therefore, the evaluation trigger signal and the evaluation stop signal can be respectively used to activate and deactivate the evaluation of the one or more conditions. In some embodiments, one or both of the evaluation trigger signal and evaluation stop signal may be transmitted as a MAC CE. Since the MAC layer is closer to the physical layer than higher layers such as the RRC layer, the use of a MAC CE allows for rapid transmission and the evaluation trigger signal and evaluation stop signal and therefore allows for rapid activation and deactivation of the evaluation of the one or more conditions.

### Evaluation Restart Signal

In some embodiments, another signal (referred to herein as an “evaluation restart signal”) subsequent to the evaluation stop signal is transmitted to the communications device by the source infrastructure equipment to indicate to the communications device to restart evaluating the one or more conditions.

In some embodiments, the source infrastructure equipment may transmit the evaluation restart signal to the communications device in response to yet another change in NES mode of at least one of the source and target cell. For example, the source infrastructure equipment may transmit the evaluation stop signal to the communications device in response to determining that the target cell has changed from the “NES MODE OFF” state to the “NES MODE ON” state. Then, in response to later determining that the target cell has changed from the “NES MODE ON” state to the “NES MODE OFF” state, the source infrastructure equipment may transmit the evaluation restart signal to the communications device.

References to the evaluation restart signal being transmitted in response to “yet another change in NES mode of at least one of the source and target cell” includes cases where:
The evaluation stop signal is transmitted in response to a change, or expected change, in the NES mode of the source cell and the evaluation restart signal is transmitted in response to a change, or expected change, in the NES mode of the source cell,
The evaluation stop signal is transmitted in response to a change, or expected change, in the NES mode of the target cell and the evaluation restart signal is transmitted in response to a change, or expected change, in the NES mode of the target cell,
The evaluation stop signal is transmitted in response to a change, or expected change, in the NES mode of the source cell and the evaluation restart signal is transmitted in response to a change, or expected change, in the NES mode of the target cell, and
The evaluation stop signal is transmitted in response to a change, or expected change, in the NES mode of the target cell and the evaluation restart signal is transmitted in response to a change, or expected change, in the NES mode of the source cell.

In some embodiments, the evaluation restart signal may be transmitted based on the expiry of a preconfigured timer.

Therefore, the evaluation restart signal can be used to reactivate the evaluation of the one or more conditions. In some embodiments, the evaluation restart signal may be transmitted as a MAC CE. Since the MAC layer is closer to the physical layer than higher layers such as the RRC layer, the use of a MAC CE allows for rapid transmission and the evaluation restart signal allows for rapid reactivation of the evaluation of the one or more conditions.

In an example, a wireless communications network may comprise a plurality of candidate target cells (for example, three candidate target cells). The candidate target cells may be provided by the same or different target infrastructure equipment. A source infrastructure equipment may configure a communication device in a source cell provided by the source infrastructure equipment with configurations for each of the plurality of candidate target cells. For example, the communications device may be configured with configurations such as measurements and/or conditions for handing over to each of the plurality of candidate target cells.

In conventional conditional handover, the communications device may evaluate the handover conditions for each of the plurality of candidate target cells and will handover to the candidate target cell for which a handover condition is satisfied (for example, because a threshold has been met for an event).

However, in accordance with example embodiments, the communications device may or may not evaluate the handover conditions for candidate target cells based on the NES mode of the candidate target cell. For example, a first and a second of the plurality of candidate target cells may not be in an NES mode whereas a third of the plurality of target cells may be in an NES mode (for example, the third target cell may be switched off). In accordance with example embodiments, the communications device may be evaluating the conditions for handing over to the first target cell and the second target cell. However, the communications device may determine that the conditions for handing over to the first target cell and the second target cell are not met. In some cases, the communications device is continuously evaluating the handover conditions for the first target cell and the second target cell. This evaluation may go on for some time if the handover conditions are not met. At a later stage, there may be a change in NES mode of the third target cell. For example, the third target cell may switch ON. In accordance with example embodiments, the source infrastructure equipment may determine that the NES mode of the third target cell has changed and, in response, transmits a signal to the communications device indicating to evaluate the conditions for handing over to the third target cell. The communications device may then evaluate the conditions for handing over to the first target cell, the conditions for handing over to the second target cell and the conditions for handing over to the third target cell. The communications device will handover to the target cell for which a handover condition is met first. Therefore, in some examples, the communications device may handover to the second target cell and, in other examples, the communications device may handover to the first target cell and, in other examples, the communications device may handover to the third target cell. In some examples, the communications device evaluates the conditions for handing over to the third target cell instead of the conditions for handing over to the first target cell and the second target cell because the indication to evaluate the conditions for the third target cell was received later.

### Example Conditions for Handover

As explained above, the source infrastructure equipment configures one or more conditions for the communications device which, if met, lead to handover of the communications device from the source cell to the target cell. The following are further examples of such conditions:
If the source cell has changed, or is expected to change, to an NES MODE ON state (for example, to a deep sleep NES mode or where the cell is turned OFF), the communications device will handover from the source cell to the target cell. In an example, the source infrastructure equipment may transmit the evaluation trigger signal to the communications device after determining that the NES mode of the source cell has changed. In this way, the source infrastructure equipment is able to promote network energy saving by entering an NES MODE ON state and therefore offload its communications devices to the target cell.
If the target cell has changed, or is expected to change, to an NES MODE OFF state or to a low power NES mode (for example, to a relatively high power NES mode such as the light sleep NES mode), the communications device will handover from the source cell to the target cell. In an example, the source infrastructure equipment may transmit the evaluation trigger signal to the communications device after determining that the NES mode of the target cell has changed. In this way, the target infrastructure equipment is able to accept new communications devices when it switches to an NES MODE OFF state or to a low power NES mode.
If the source cell has changed, or is expected to change, to an NES MODE OFF state (or to a low power NES mode (for example, to a relatively high power NES mode such as the light sleep NES mode), the communications device will handover from the source cell to the target cell. In an example, the source infrastructure equipment may transmit the evaluation trigger signal to the communications device after determining that the NES mode of the source cell has changed. In this example, communications device preferring to operate in an NES MODE ON can be offloaded to the target cell to promote energy savings.
If the target cell has changed, or is expected to change, to an NES MODE ON state (for example, to a deep sleep NES mode), the communications device will handover from the source cell to the target cell. In an example, the source infrastructure equipment may transmit the evaluation trigger signal to the communications device after determining that the NES mode of the target cell has changed. In this way, the target infrastructure equipment is able to accept new communications devices which prefer to operate in an NES MODE ON state to promote energy savings.

It will be appreciated that while the present disclosure has in some respects focused on implementations in an LTE-based and/or 5G network for the sake of providing specific examples, the same principles can be applied to other wireless telecommunications systems. Thus, even though the terminology used herein is generally the same or similar to that of the LTE and 5G standards, the teachings are not limited to the present versions of LTE and 5G and could apply equally to any appropriate arrangement not based on LTE or 5G and/or compliant with any other future version of an LTE, 5G or other standard.

It may be noted various example approaches discussed herein may rely on information which is predetermined/predefined in the sense of being known by both the base station and the communications device. It will be appreciated such predetermined/predefined information may in general be established, for example, by definition in an operating standard for the wireless telecommunication system, or in previously exchanged signalling between the base station and communications devices, for example in system information signalling, or in association with radio resource control setup signalling, or in information stored in a SIM application. That is to say, the specific manner in which the relevant predefined information is established and shared between the various elements of the wireless telecommunications system is not of primary significance to the principles of operation described herein. It may further be noted various example approaches discussed herein rely on information which is exchanged/communicated between various elements of the wireless telecommunications system and it will be appreciated such communications may in general be made in accordance with conventional techniques, for example in terms of specific signalling protocols and the type of communication channel used, unless the context demands otherwise. That is to say, the specific manner in which the relevant information is exchanged between the various elements of the wireless telecommunications system is not of primary significance to the principles of operation described herein.

It will be appreciated that the principles described herein are not applicable only to certain types of communications device, but can be applied more generally in respect of any types of communications device, for example the approaches are not limited to URLLC/IIOT devices or other low latency communications devices, but can be applied more generally, for example in respect of any type of communications device operating with a wireless link to the communication network.

It will further be appreciated that the principles described herein are applicable not only to LTE-based or 5G/NR-based wireless telecommunications systems, but are applicable for any type of wireless telecommunications system that supports a dynamic scheduling of shared communications resources.

Further particular and preferred aspects of the present invention are set out in the accompanying independent and dependent claims. It will be appreciated that features of the dependent claims may be combined with features of the independent claims in combinations other than those explicitly set out in the claims.

Thus, the foregoing discussion discloses and describes merely exemplary embodiments of the present invention. As will be understood by those skilled in the art, the present invention may be embodied in other specific forms without departing from the spirit or essential characteristics thereof. Accordingly, the disclosure of the present invention is intended to be illustrative, but not limiting of the scope of the invention, as well as other claims. The disclosure, including any readily discernible variants of the teachings herein, define, in part, the scope of the foregoing claim terminology such that no inventive subject matter is dedicated to the public.

Respective features of the present disclosure are defined by the following numbered paragraphs:
Paragraph 1. A method of operating a source infrastructure equipment of a wireless communications network in a conditional handover, the method comprising
   configuring one or more conditions for triggering a handover of a communications device from a source cell provided by the source infrastructure equipment to a target cell provided by a target infrastructure equipment of the wireless communications network,
   transmitting, to the communications device, an indication of the one or more conditions for triggering the handover of the communications device from the source cell to the target cell,
   determining that a Network Energy Saving, NES, mode of at least one of the source cell and the target cell has changed or is expected to change, and in response,
   transmitting an evaluation trigger signal to the communications device, the evaluation trigger signal indicating to the communications device to evaluate one or more of the conditions for triggering the handover of the communications device from the source cell to the target cell.
Paragraph 2. A method according to paragraph 1, comprising
   transmitting an evaluation stop signal indicating to the communications device to stop evaluating the one or more conditions for triggering the handover of the communications device from the source cell to the target cell.
Paragraph 3. A method according to paragraph 2, comprising
   transmitting an evaluation restart signal indicating to the communications device to restart evaluating the one or more conditions for triggering the handover of the communications device from the source cell to the target cell.
Paragraph 4. A method according to paragraph 3, wherein one or more of the evaluation trigger signal, the evaluation stop signal and the evaluation restart signal are transmitted in a Medium Access Control, MAC, Control Element, CE.
Paragraph 5. A method according to any of paragraphs 1 to 4, wherein the evaluation trigger signal comprises an indication of the NES mode of at least one of the source cell and the target cell.
Paragraph 6. A method according to any of paragraphs 1 to 4, wherein the evaluation trigger signal is a Radio Resource Control, RRC, signal dedicated for the communications device.
Paragraph 7. A method according to any of paragraphs 1 to 4, wherein the evaluation trigger signal is a groupcast Radio Resource Control, RRC, signal for reception by a plurality of communications devices in the source cell, the groupcast RRC signal comprising a Group Common, GC, Radio Network Temporary identifier, RNTI, for identifying the plurality of communications devices in the source cell.
Paragraph 8. A method according to any of paragraphs 1 to 4, wherein the evaluation trigger signal is a Medium Access Control, MAC, signal dedicated for the communications device.
Paragraph 9. A method according to any of paragraphs 1 to 4, wherein the evaluation trigger signal is a groupcast Medium Access Control, MAC, signal for reception by a plurality of communications devices in the source cell, the groupcast MAC signal comprising a Group Common, GC, Radio Network Temporary identifier, RNTI, for identifying the plurality of communications devices in the source cell.
Paragraph 10. A method according to any of paragraphs 1 to 4, wherein the evaluation trigger signal is a broadcast signal for reception by a plurality communications devices in the source cell.
Paragraph 11. A method according to any of paragraphs 1 to 4, wherein the evaluation trigger signal is comprised in group common downlink control information, DCI, for reception by a plurality of communications devices in the source cell, the group common DCI comprising a Group Common, GC, Radio Network Temporary Identifier, RNTI, for identifying the plurality of communications devices in the source cell.
Paragraph 12. A method according to any of paragraphs 1 to 11, wherein the determining that the NES mode of at least one source cell and the target cell has changed or is expected to change comprises
   receiving, from the target infrastructure equipment, an indication that the NES mode of the target cell has changed or is expected to change.
Paragraph 13. A method according to paragraph 12, wherein the indication that the NES mode of the target infrastructure equipment has changed is transmitted via an Xn interface between the source infrastructure equipment and the target infrastructure equipment.
Paragraph 14. A method according to any of paragraphs 1 to 11, wherein the determining that the NES mode of at least one of the source cell and the target cell has changed or is expected to change comprises
   receiving, from the target infrastructure equipment, an indication to transmit the evaluation trigger signal to the communications device in response to a change, or expected change, in the NES mode of the target cell.
Paragraph 15. A method according to paragraph 14, comprising
   transmitting, to the target infrastructure equipment, handover assistance information comprising one or more of a number of communications devices in the source cell as candidates for handover to the target cell, a quality of service required by the communications devices, a service required by the communications devices and a traffic volume required by the communications devices.
Paragraph 16. A method of operating a communications device in a conditional handover, the method comprising
   receiving, from source infrastructure equipment of a wireless communications network, an indication of one or more conditions for triggering a handover of the communications device from a source cell provided by the source infrastructure equipment to a target cell provided by a target infrastructure of the wireless communications network,
   receiving, from the source infrastructure equipment, an evaluation trigger signal indicating to the communications device to evaluate one or more of the conditions for triggering the handover of the communications device from the source cell to the target cell, the evaluation trigger signal being received by the communications device from the source infrastructure equipment in response to a change, or expected change, in a Network Energy Saving, NES, mode of at least one of the source cell and target cell, and in response,
   evaluating one or more of the conditions for triggering the handover of the communications device from the source cell to the target cell,
   determining that one or more of the evaluated conditions have been met, and in response, and
   initiating the handover of the communications device from the source cell to the target cell.
Paragraph 17. A method according to paragraph 16, comprising
   receiving an evaluation stop signal indicating to the communications device to stop evaluating the one or more conditions for triggering the handover of the communications device from the source cell to the target cell.
Paragraph 18. A method according to paragraph 16, comprising
   receiving an evaluation restarting signal indicating to the communications device to restart evaluating the one or more conditions for triggering the handover of the communications device from the source cell to the target cell.
Paragraph 19. A method according to paragraph 18, wherein one or more of the evaluation trigger signal, the evaluation stop signal and the evaluation restart signal are received in a Medium Access Control, MAC, Control Element, CE.
Paragraph 20. A method according to any of paragraphs 16 to 19, wherein the evaluation trigger signal comprises an indication of the NES mode of at least one of the source cell and the target cell.
Paragraph 21. A method according to any of paragraphs 16 to 20, wherein the evaluation trigger signal is a Radio Resource Control, RRC, signal dedicated for the communications device.
Paragraph 22. A method according to any of paragraphs 16 to 20, wherein the evaluation trigger signal is a groupcast Radio Resource Control, RRC, signal for reception by a plurality of communications devices in the source cell, the groupcast RRC signal comprising a Group Common, GC, Radio Network Temporary identifier, RNTI, for identifying the plurality of communications devices in the source cell.
Paragraph 23. A method according to any of paragraphs 16 to 20, wherein the evaluation trigger signal is a Medium Access Control, MAC, signal dedicated for the communications device.
Paragraph 24. A method according to any of paragraphs 16 to 20, wherein the evaluation trigger signal is a groupcast Medium Access Control, MAC, signal for reception by a plurality of communications devices in the source cell, the groupcast MAC signal comprising a Group Common, GC, Radio Network Temporary Identifier, RNTI, for identifying the plurality of communications devices in the source cell.
Paragraph 25. A method according to any of paragraphs 16 to 20 wherein the evaluation trigger signal is a broadcast signal for reception by a plurality communications devices in the source cell.
Paragraph 26. A method according to any of paragraphs 16 to 20, wherein the evaluation trigger signal is comprised in group common downlink control information, DCI, for reception by a plurality of communications devices in the source cell, the group common DCI comprising a Group Common, GC, Radio Network Temporary identifier, RNTI, for identifying the plurality of communications devices in the source cell.
Paragraph 27. A source infrastructure equipment of a wireless communications network for use in a conditional handover, the source infrastructure equipment comprising
   a transmitter configured to transmit signals;
   a receiver configured to receive signals;
   a controller configured in combination with the transmitter and the receiver to
   configure one or more conditions for triggering a handover of a communications device from a source cell provided by the source infrastructure equipment to a target cell provided by a target infrastructure equipment of the wireless communications network,
   transmit, to the communications device, an indication of the one or more conditions for triggering the handover of the communications device from the source cell to the target cell,
   determine that a Network Energy Saving, NES, mode of at least one of the source cell and the target cell has changed or is expected to change, and in response,
   transmit an evaluation trigger signal to the communications device, the evaluation trigger signal indicating to the communications device to evaluate one or more of the conditions for triggering the handover of the communications device from the source cell to the target cell.
Paragraph 28. A communications device for use in a conditional handover, the communications device comprising
   a transmitter configured to transmit signals;
   a receiver configured to receive signals;
   a controller configured in combination with the transmitter and the receiver to
   receive, from source infrastructure equipment of a wireless communications network, an indication of one or more conditions for triggering a handover of the communications device from a source cell provided by the source infrastructure equipment to a target cell provided by a target infrastructure of the wireless communications network,
   receive, from the source infrastructure equipment, an evaluation trigger signal indicating to the communications device to evaluate one or more of the conditions for triggering the handover of the communications device from the source cell to the target cell, the evaluation trigger signal being received by the communications device from the source infrastructure equipment in response to a change, or expected change, in a Network Energy Saving, NES, mode of at least one of the source cell and target cell, and in response,
   evaluate one or more of the conditions for triggering the handover of the communications device from the source cell to the target cell,
   determine that one or more of the evaluated conditions have been met, and in response, and
   initiate the handover of the communications device from the source cell to the target cell.
Paragraph 29. Circuitry for a source infrastructure equipment of a wireless communications network for use in a conditional handover, the circuitry comprising
   transmitter circuitry configured to transmit signals;
   receiver circuitry configured to receive signals;
   controller circuitry configured in combination with the transmitter circuitry and the receiver circuitry to
   configure one or more conditions for triggering a handover of a communications device from a source cell provided by the source infrastructure equipment to a target cell provided by a target infrastructure equipment of the wireless communications network,
   transmit, to the communications device, an indication of the one or more conditions for triggering the handover of the communications device from the source cell to the target cell,
   determine that a Network Energy Saving, NES, mode of at least one of the source cell and the target cell has changed or is expected to change, and in response,
   transmit an evaluation trigger signal to the communications device, the evaluation trigger signal indicating to the communications device to evaluate one or more of the conditions for triggering the handover of the communications device from the source cell to the target cell.
Paragraph 30. Circuitry for a communications device for use in a conditional handover, the circuitry comprising
   transmitter circuitry configured to transmit signals;
   receiver circuitry configured to receive signals;
   controller circuitry configured in combination with the transmitter circuitry and the receiver circuitry to
   receive, from source infrastructure equipment of a wireless communications network, an indication of one or more conditions for triggering a handover of the communications device from a source cell provided by the source infrastructure equipment to a target cell provided by a target infrastructure of the wireless communications network,
   receive, from the source infrastructure equipment, an evaluation trigger signal indicating to the communications device to evaluate one or more of the conditions for triggering the handover of the communications device from the source cell to the target cell, the evaluation trigger signal being received by the communications device from the source infrastructure equipment in response to a change, or expected change, in a Network Energy Saving, NES, mode of at least one of the source cell and target cell, and in response,
   evaluate one or more of the conditions for triggering the handover of the communications device from the source cell to the target cell,
   determine that one or more of the evaluated conditions have been met, and in response, and
   initiate the handover of the communications device from the source cell to the target cell.
Paragraph 31. A wireless communications network comprising a source infrastructure equipment according to paragraph 27 and a communications device according to paragraph 28.
Paragraph 32. A computer program comprising instructions which, when loaded onto a computer, cause the computer to perform a method according to any of paragraphs 1 to 26.
Paragraph 33. A non-transitory computer-readable storage medium storing a computer program according to paragraph 32.

### REFERENCES

[1] RP-182090, “Revised SID: Study on NR Industrial Internet of Things (IOT),” 3GPP RAN #81.
[2] Holma H. and Toskala A, “LTE for UMTS OFDMA and SC-FDMA based radio access”, John Wiley and Sons, 2009.
[3] TS38.300 V16.5.0, “NG and NR-RAN Overall Description”, Release 16.
[4] RP-213554, “Study on network energy savings for NR”.
[5] TR38.840, “Study on User Equipment (UE) power saving in NR”, Release 16.
[6] TR38.864, “Study on network energy savings for NR”, Release 18.
[7] R2-2213040, “Post RAN2 #120 TP for TR 38.864”, Release 18.

1. A method of operating a source infrastructure equipment of a wireless communications network in a conditional handover, the method comprising
configuring one or more conditions for triggering a handover of a communications device from a source cell provided by the source infrastructure equipment to a target cell provided by a target infrastructure equipment of the wireless communications network,
transmitting, to the communications device, an indication of the one or more conditions for triggering the handover of the communications device from the source cell to the target cell,
determining that a Network Energy Saving, NES, mode of at least one of the source cell and the target cell has changed or is expected to change, and in response,
transmitting an evaluation trigger signal to the communications device, the evaluation trigger signal indicating to the communications device to evaluate one or more of the conditions for triggering the handover of the communications device from the source cell to the target cell.

2. A method according to claim 1, comprising
transmitting an evaluation stop signal indicating to the communications device to stop evaluating the one or more conditions for triggering the handover of the communications device from the source cell to the target cell.

3. A method according to claim 2, comprising
transmitting an evaluation restart signal indicating to the communications device to restart evaluating the one or more conditions for triggering the handover of the communications device from the source cell to the target cell.

4. A method according to claim 3, wherein one or more of the evaluation trigger signal, the evaluation stop signal and the evaluation restart signal are transmitted in a Medium Access Control, MAC, Control Element, CE.

5. A method according to claim 1, wherein the evaluation trigger signal comprises an indication of the NES mode of at least one of the source cell and the target cell.

6. A method according to claim 1, wherein the evaluation trigger signal is a Radio Resource Control, RRC, signal dedicated for the communications device.

7. A method according to claim 1, wherein the evaluation trigger signal is a groupcast Radio Resource Control, RRC, signal for reception by a plurality of communications devices in the source cell, the groupcast RRC signal comprising a Group Common, GC, Radio Network Temporary identifier, RNTI, for identifying the plurality of communications devices in the source cell.

8. A method according to claim 1, wherein the evaluation trigger signal is a Medium Access Control, MAC, signal dedicated for the communications device.

9. A method according to claim 1, wherein the evaluation trigger signal is a groupcast Medium Access Control, MAC, signal for reception by a plurality of communications devices in the source cell, the groupcast MAC signal comprising a Group Common, GC, Radio Network Temporary identifier, RNTI, for identifying the plurality of communications devices in the source cell.

10. A method according to claim 1, wherein the evaluation trigger signal is a broadcast signal for reception by a plurality communications devices in the source cell.

11. A method according to claim 1, wherein the evaluation trigger signal is comprised in group common downlink control information, DCI, for reception by a plurality of communications devices in the source cell, the group common DCI comprising a Group Common, GC, Radio Network Temporary Identifier, RNTI, for identifying the plurality of communications devices in the source cell.

12. A method according to claim 1, wherein the determining that the NES mode of at least one source cell and the target cell has changed or is expected to change comprises
receiving, from the target infrastructure equipment, an indication that the NES mode of the target cell has changed or is expected to change.

13. A method according to claim 12, wherein the indication that the NES mode of the target infrastructure equipment has changed is transmitted via an Xn interface between the source infrastructure equipment and the target infrastructure equipment.

14. A method according to claim 1, wherein the determining that the NES mode of at least one of the source cell and the target cell has changed or is expected to change comprises receiving, from the target infrastructure equipment, an indication to transmit the evaluation trigger signal to the communications device in response to a change, or expected change, in the NES mode of the target cell.

15. A method according to claim 14, comprising
transmitting, to the target infrastructure equipment, handover assistance information comprising one or more of a number of communications devices in the source cell as candidates for handover to the target cell, a quality of service required by the communications devices, a service required by the communications devices and a traffic volume required by the communications devices.

16.-26. (canceled)

27. A source infrastructure equipment of a wireless communications network for use in a conditional handover, the source infrastructure equipment comprising
a transmitter configured to transmit signals;
a receiver configured to receive signals;
a controller configured in combination with the transmitter and the receiver to configure one or more conditions for triggering a handover of a communications device from a source cell provided by the source infrastructure equipment to a target cell provided by a target infrastructure equipment of the wireless communications network,
transmit, to the communications device, an indication of the one or more conditions for triggering the handover of the communications device from the source cell to the target cell,
determine that a Network Energy Saving, NES, mode of at least one of the source cell and the target cell has changed or is expected to change, and in response,
transmit an evaluation trigger signal to the communications device, the evaluation trigger signal indicating to the communications device to evaluate one or more of the conditions for triggering the handover of the communications device from the source cell to the target cell.

28. A communications device for use in a conditional handover, the communications device comprising
a transmitter configured to transmit signals;
a receiver configured to receive signals;
a controller configured in combination with the transmitter and the receiver to
receive, from source infrastructure equipment of a wireless communications network, an indication of one or more conditions for triggering a handover of the communications device from a source cell provided by the source infrastructure equipment to a target cell provided by a target infrastructure of the wireless communications network,
receive, from the source infrastructure equipment, an evaluation trigger signal indicating to the communications device to evaluate one or more of the conditions for triggering the handover of the communications device from the source cell to the target cell, the evaluation trigger signal being received by the communications device from the source infrastructure equipment in response to a change, or expected change, in a Network Energy Saving, NES, mode of at least one of the source cell and target cell, and in response,
evaluate one or more of the conditions for triggering the handover of the communications device from the source cell to the target cell,
determine that one or more of the evaluated conditions have been met, and in response, and
initiate the handover of the communications device from the source cell to the target cell.

29.-33. (canceled)
